(19) United States
(12) Patent Application Publication
(10) Pub. No.: US 2014/0196709 A1
(43) Pub. Date: Jul. 17, 2014

(54) PROTECTIVE ACCESSORY DEVICE FOR FREESTANDING OUTDOOR COOKING UNITS

(71) Applicant: Jeremiah Ouimette, LaFayette, NY (US)

(72) Inventor: Jeremiah Ouimette, LaFayette, NY (US)

(21) Appl. No.: 13/860,292

(22) Filed: Apr. 10, 2013

Related U.S. Application Data
(60) Provisional application No. 61/622,228, filed on Apr. 10, 2012.

(51) Int. Cl. F24C 15/36; A47J 37/07

(52) U.S. Cl. CPC F24C 15/36; A47J 37/0786
USPC 126/201

(57) ABSTRACT

A safety device for outdoor cooking grills having a plurality of base pieces that are linearly joined such that they may be folded together for transportation or unfolded for use by interlocking the first piece with the last piece to form an enclosure. Depending on the number of base pieces used, the enclosure may take the form of triangle, octagon, or other geometric shape, and may contain an opening to facilitate ventilation. A top piece having a central opening for permitting access to the grill and an indented access point to allow a user to stand closer to the grill is positioned over the base pieces.

### RELATED APPLICATION DATA

The present application claims the benefit of U.S. provisional patent application No. 61/622,228, filed Apr. 10, 2012, and is hereby incorporated by reference in its entirety.

### BACKGROUND OF THE INVENTION

1. Field of the Invention

The invention generally relates to freestanding outdoor cooking units, such as charcoal grills. More particularly, the invention relates to a collapsible, portable, multi-use protective enclosure and stable adjacent surface for preventing contact with hot outer portions of the cooking unit and serving as a work space or food preparation area.

2. Description of the Related Art

Outdoor cooking units are widely used. Although these devices are commercially available in several forms, many are freestanding, such as simple charcoal grills. In some embodiments, these freestanding outdoor cooking units consist of a semi-spherical bottom bowl with a circular opening at the top and a hinged or removable lid having the same circumference as the opening in the bottom bowl. Inside the bottom bowl, a grate, mesh, or other cooking surface is supported above a cooking chamber containing hot coals. The entire unit is supported on a leg arrangement.

The outer surfaces of the devices described above reach extremely high temperatures while in use. Consequently, any human or animal contact with the outer surface can cause serious burns and leave lasting scars. The risk of burn injuries is particularly high when these devices are used in a residential or recreational setting in the presence of small children, who are curious but incapable of understanding the risk of injury. Given the freestanding nature of the cooking units and leg arrangements, there is an additional risk of burn injury resulting from collision with the leg arrangement which may turn over the entire cooking unit.

Additionally, the devices described above do not provide any affixed or adjacent work space or food preparation area. Consequently, users are unable to prepare or set food down close to the cooking unit, unable to set down cooking tools, and unable to readily access serving dishes or other means for transporting food between a preparation area and the cooking unit.

Various approaches have been used to address these concerns independently. U.S. Pat. No. 5,590,640 discloses a rigid protective guard which can be affixed to the outer portion of a freestanding outdoor cooking unit to protect against burn injuries resulting from contact with the sides of the cooking unit. However, this approach does not consider nor protect against burn injuries which may be sustained as a result of contact with the top, the bottom, or the legs of the cooking unit.

U.S. Pat. No. 3,757,675 discloses a barbeque grill with expandable metal sides designed to prevent inadvertent contact with hot outer surfaces of the grill. However, this design is neither independently portable nor interoperable with other grill models and does not protect against injury as a result of contact with the top, the bottom, or the legs of the grill, nor does it prevent the grill from overturning.

U.S. Pat. No. 6,439,220 discloses a barbeque grill frame assembly that provides a work surface or food preparation area adjacent to the cooking chamber of a freestanding outdoor cooking unit. However, the device of this patent is not collapsible, portable, and does not consider burn protection.

There is a need for a device that simultaneously protects against burn injuries by surrounding all portions of a freestanding cooking unit's outer surfaces and providing a work space or food preparation area.

### BRIEF SUMMARY OF THE INVENTION

Therefore, it is an object of the present invention to provide burn protection by enclosing a freestanding outdoor cooking unit.

It is a further object of the present invention to provide a work space or food preparation area adjacent to the cooking chamber.

It is a further object of the present invention to require minimal assembly, easy compaction for convenient transport, and operability with multiple freestanding outdoor cooking unit models, or with no cooking unit at all.

In accordance with these objects, the present invention comprises a collapsible, portable, protective enclosure and work space or food preparation area designed for use with multiple models of freestanding outdoor cooking units, or for use with no cooking unit at all. When in use, the present invention surrounds the entire cooking unit and extends from the ground vertically to waist height of an average adult. The cooking unit, housed centrally within the base, is exposed to the user through a circular opening in the top piece, which fastens to the upper portion of the base and serves as a work space or food preparation area.

The device is simple in design, but enables enhanced safety and functionality for freestanding outdoor cooking units. Further, the present invention is comprised of three primary elements which can be assembled quickly with no mechanical skill or knowledge. Each element is light weight, collapsible, and designed for convenient transport and storage.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of the protection and preparation accessory device for outdoor cooking units incorporating an embodiment of the present invention.

FIG. 2 is a perspective view of the top piece insert.

FIG. 3 is an overhead view of the top piece.

FIGS. 4-8 are photographs showing the assembly of an embodiment according to the present invention;

FIGS. 9 and 10 are photographs showing the assembly of other embodiments of the present invention;

FIG. 11 is an exploded view of a schematic representation of an alternative embodiment of a protective enclosure assembly for a cooking unit/protective and preparation device, according to an embodiment of the present invention.

FIGS. 12A through 12C are a top view (a), a side view (b), and a perspective view (c) of a schematic representation of an alternative embodiment of a protective enclosure assembly for a cooking unit/protective and preparation device, according to an embodiment of the present invention.

FIGS. 13A through 13C are a top view (a), a side view (b), and a perspective view (c) of a schematic representation of a frame unit, according to an embodiment of the present invention.

FIG. 14 is an outer perimeter side view, a top side view, and inner perimeter side view, and a top perspective view of a schematic representation of a top piece unit panel, according to an embodiment of the present invention.

FIGS. 15A through 15B are a top view (a) and a top perspective view (b) of a schematic representation of a top piece unit, according to an alternative embodiment of the present invention.

FIGS. 16A through 16D is a side view (a), top view (b), side view (c), and perspective view (d) of a side panel, according to an embodiment of the present invention.

### DETAILED DESCRIPTION OF THE INVENTION

While this invention is susceptible to several embodiments, there is shown in the drawings and will be herein described in detail a preferred embodiment with the understanding that the present disclosure is to be considered as an exemplification of the principles of the invention and is not intended to limit the broad aspects of the invention to the embodiments illustrated.

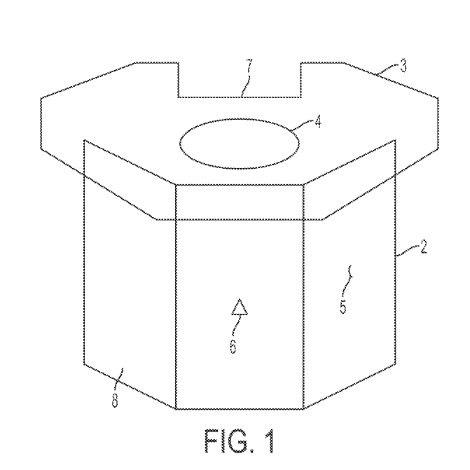

Referring now to the drawings, wherein like reference numerals refer to like parts throughout, there is seen in FIG. 1 a protective and preparation device (or a protective enclosure assembly for a cooking unit) 1 having a base 2 and a top piece 3. Top piece 3 contains a central circular opening 4 which allows a user to access an enclosed cooking unit. Top piece 3 includes an indented access point 7 which enables a user to reach the cooking unit comfortably. Base 2 is comprised of a plurality of linearly connected panels 8, the first and last of which connect to enclose a cooking unit. Linearly connected panels 08 are equipped with a multi-purpose fastening means 5 and contain a plurality of vents 06 to allow heat generated during cooking to escape safely. Thus, device 1 consists of a plurality of base pieces identical in height. In one embodiment, the device consists of three base pieces. In another embodiment, the device consists of eight base pieces. Other embodiments can consist of any number of base pieces. In any embodiment, the base pieces are linearly joined such that they may be folded together for transportation or unfolded for use by interlocking the first piece with the last piece to form an enclosure. Depending on the number of base pieces used, the enclosure may take the form of triangle, octagon, or other geometric shape. Each base piece preferably contains an opening to facilitate ventilation. In some embodiments, additional accessories are affixed to one or many base pieces, and may include fixtures for hanging, cleaning, or supporting tools and products commonly used in outdoor cooking.

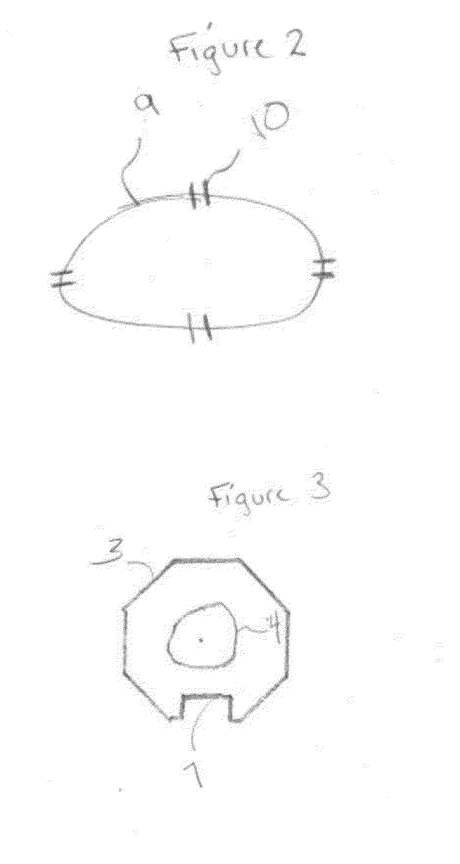

FIG. 2 depicts the top piece insert 9, which may take the form of a circle or any other geometric shape and may or may not correspond to the geometric shape formed by the assembled base. In any embodiment, the top piece includes a central opening, which may take any geometric shape. In some embodiments, the top piece may include an indented access point, which allows a user to easily access the unit's cooking surface or to cover or uncover the cooking surface. For example, FIG. 3 depicts an overhead view of top piece 3, central circular opening 4, and indented access point 7. A multitude of rotatable brackets 10 may be mounted to top piece insert 9 such that, when placed into central circular opening 4, top piece insert 9 can be set at a height equal to top piece 3, higher than top piece 3, or lower than top piece 3.

The top piece may consist of one or more sections. In an embodiment including two or more top piece sections, the top piece sections are jointed such that they may be folded together for transportation or unfolded for use. When in use, the top piece section or sections are securely affixed to the vertically oriented base pieces in a covering relation. Thus, when in use, the top piece or pieces form a protective barrier at or about the height of the cooking surface as well as serving as a stable food preparation area.

Top piece insert 9 may be used in conjunction with the other components of the device. In any embodiment, the top piece insert is the same geometric shape as the central opening but slightly smaller in measure, such that when engaged with the top piece at an equal height, only a small gap exists between the top piece and the top piece insert. A plurality of adjustable connectors are removably affixed to the edges of the top piece insert. To engage the top piece insert with the top piece, a user may select a desired height equal, above, or below the top piece by positioning the connectors and interlocking them with the interior edge of the central opening.

For example, a user having an outdoor cooking unit of less than standard height may engage the top piece insert below the top piece and placing the unit on top of the insert; thus, elevating the cooking unit to a standard height. In another position, the insert may be adjusted to the same height as the top piece for use with or without the cooking unit inside the base. When the cooking unit is inside the base and has retained heat from use, the top piece insert may serve as a worming tray. At another height, the top piece insert may be positioned above the top piece, for use with or without the cooking unit inside. At this height, the top piece insert may serve as an additional food serving area.

In addition to the components described above, this device may also contain a lid removal means to mechanically elevate and store the cooking unit's lid to enable easier access to the cooking surface. The lid removal means may be affixed to the top piece or a base piece and the handle of the cooking unit's lid. To operate the lid removal means, a user may press a foot pedal or other mechanism. This component facilitates elevation and replacement of a cooking unit's lid, particularly where the lid is not permanently affixed to the cooking unit itself.

When the base pieces are assembled and engaged with the top piece or pieces, an outdoor cooking unit may only be accessed from the top, thereby preventing unintended contact with hot external surfaces of the cooking unit. Furthermore, the device provides a stable surface suitable for food preparation, consumption, or storage. Additionally, the enclosure created by the assembled device reduces the risk a cooking unit will overturn in the event a powerful, inadvertent force comes into contact with it. The device may also be aesthetically pleasing and serve as patio or other outdoor furnishing.

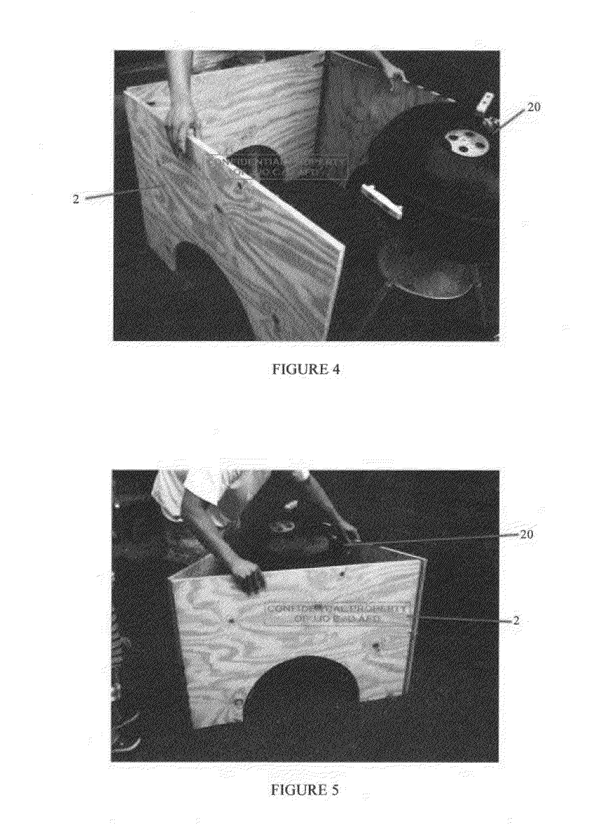

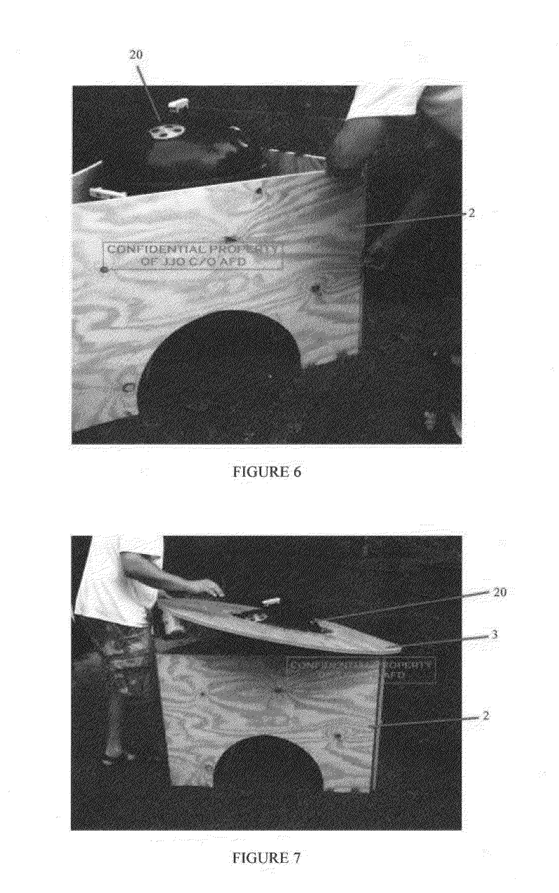

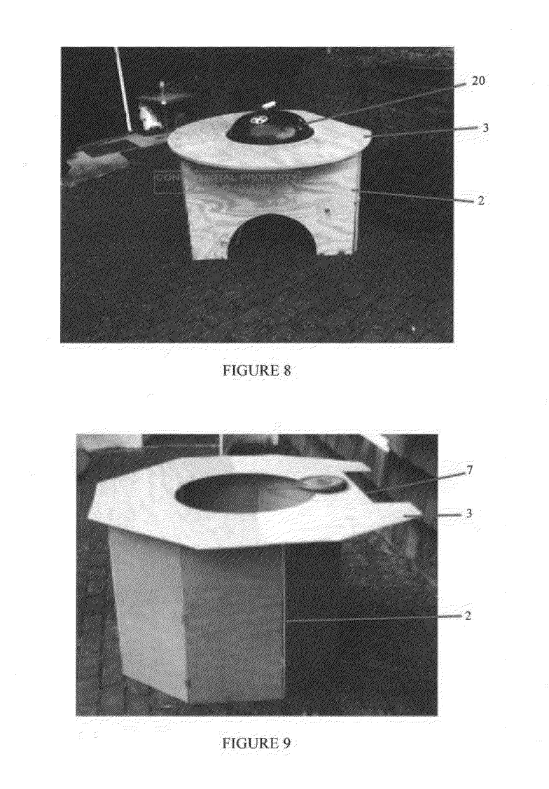

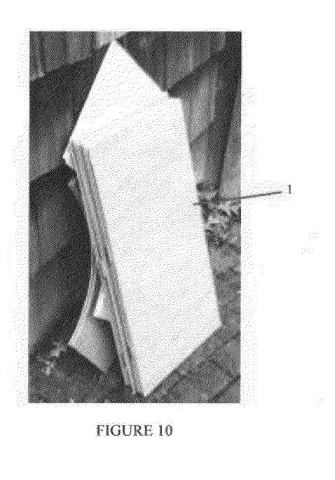

As seen in FIGS. 4-8, various photographs of the base 2, top piece 3, and cooking unit 20 are shown. To use the device with an outdoor cooking unit of standard height, a user may unfold the vertically oriented base pieces such that they enclose the cooking unit and interlock the first base piece with the last base piece to secure the enclosure. Then, the user may unfold the top piece and engage the top piece securely over the base pieces enclosing the cooking unit, such that the central opening exposes the cooking surface. When engaged with the base pieces, the top piece should accommodate either the cooking unit's lid or the top piece insert at a height equal to or set above the height of the top piece. As seen in FIG. 9, the device may have six or more pivotally interconnected section, and a top piece having a discrete cutout permitting access to the interior cooking space that, as seen in FIG. 10, may be collapsed into a convenient package for transportation or storage.

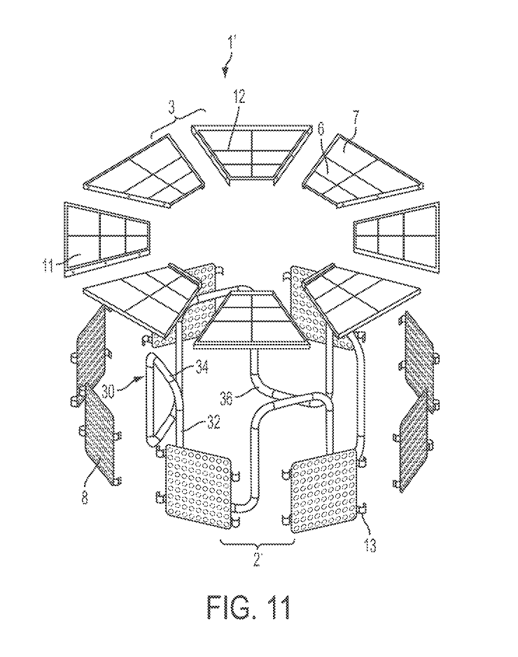

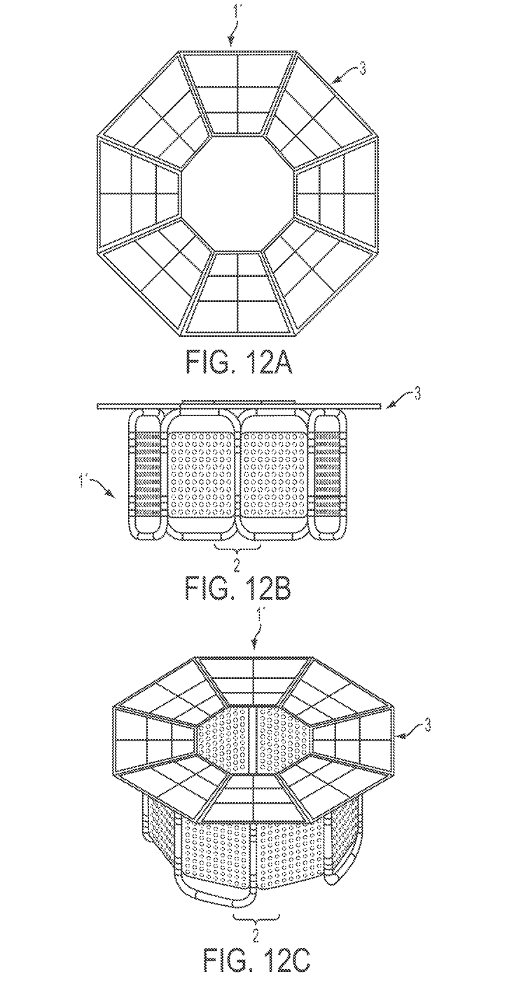

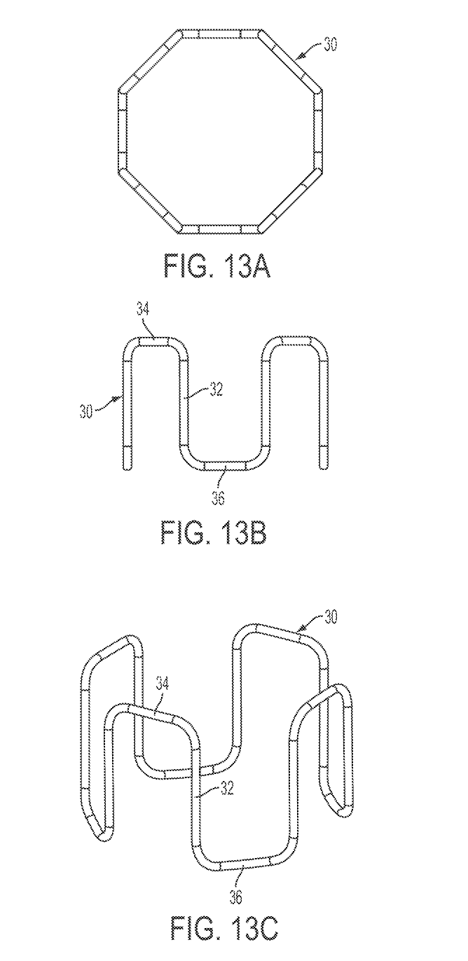

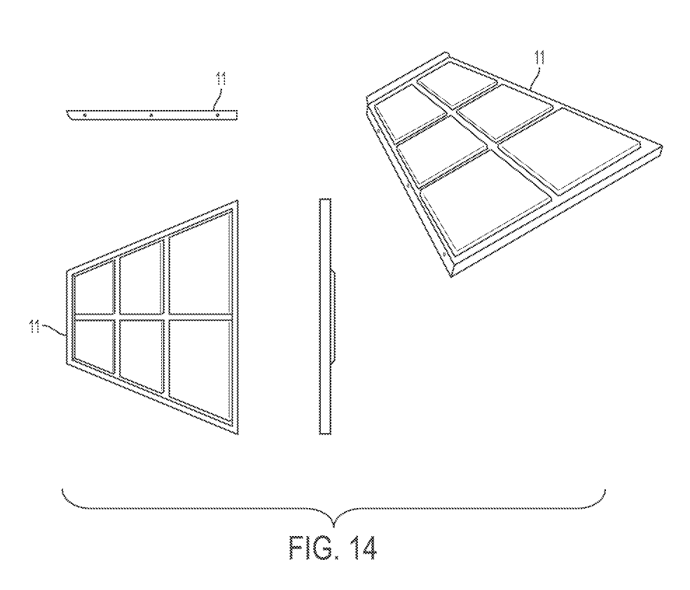

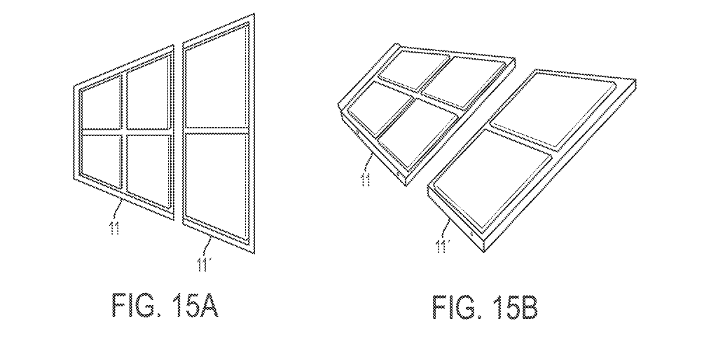

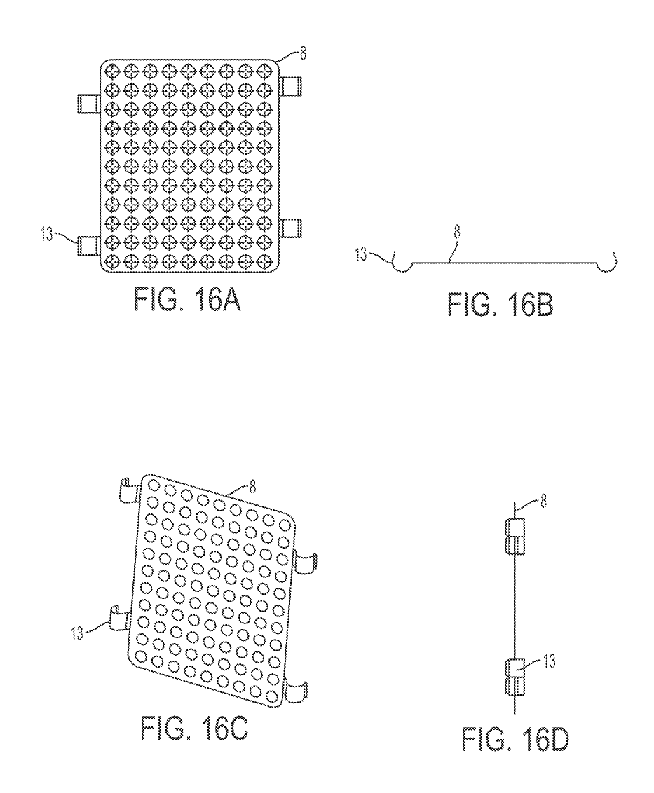

FIGS. 11-16 show various views and aspects of a schematic representation of an alternative embodiment of the protective enclosure assembly for a cooking unit/a protective and preparation device 1′, according to an embodiment of the present invention. Some of these figures list dimensions, however, these dimensions are exemplary and are not meant to be limiting in any way. A base unit 2′ including a frame unit 30 and side panels 8 are shown. The frame unit can include leg portions 32, top portions 34, and bottom portions 36. The side panels 8 can include an attachment mechanism(s) 13 which allows the side panel to snap onto, or otherwise attach to, the leg portions 32 of the frame unit 30. A top piece unit 3 including top piece unit panels 11 are also shown. The top piece unit panels 11 can include a frame portion (or ribs) 12. Each top piece unit panel 11 can be made of multiple parts 11 and 11′, as shown in FIGS. 15a-b.

While several embodiments of the invention have been discussed, it will be appreciated by those skilled in the art that various modifications and variations of the present invention are possible. Such modifications do not depart from the spirit and scope of the present invention.

What is claimed is:

1. A protective enclosure assembly for a cooking unit comprising:
a base unit comprising a plurality of linearly interconnected panels, each of which extends along a separate vertical plane from the ground when in use and forming an interior space therein, wherein said base unit is structured to enclose the cooking unit within the interior space;
a top piece unit connected to a top portion of said base unit in a covering relation and extending along a plane substantially perpendicular to each of said vertical planes, wherein an opening is formed therein permitting access to the cooking unit.

2. The protective enclosure assembly for a cooking unit of claim 1, wherein a portion of perimeter of said top piece comprises an indentation sufficient to allow closer access to the cooking unit.

3. The protective enclosure assembly for a cooking unit of claim 1, wherein said opening is substantially centrally located in said top piece unit.

4. The protective enclosure assembly for a cooking unit of claim 1, wherein at least one of said plurality of linearly interconnected panels comprises at least one vent configured to allow heat to be released from the interior space.

5. The protective enclosure assembly for a cooking unit of claim 1, wherein each of said plurality of linearly interconnected panels are substantially the same size.

6. The protective enclosure assembly for a cooking unit of claim 1, wherein each of said plurality of linearly interconnected panels are jointed and at least two adjacent plurality of linearly interconnected panels are releasably interlocked such that said plurality of linearly interconnected panels may be folded together when not in use.

7. The protective enclosure assembly for a cooking unit of claim 1, wherein said top piece unit further comprises a plurality of linearly interconnected panels.

8. The protective enclosure assembly for a cooking unit of claim 7, wherein each of said plurality of linearly interconnected panels of said top piece are jointed and at least two adjacent plurality of linearly interconnected panels of said top piece are releasably interlocked such that said plurality of linearly interconnected panels of said top piece may be folded together when not in use.

9. The protective enclosure assembly for a cooking unit of claim 1, further comprising a top piece insert structured to fit within said opening and comprising at least one rotatable bracket mounted thereon and structured to adjust the vertical height of the top piece insert with respect to the top piece unit when in use.

10. A protective enclosure assembly for a cooking unit comprising:
a base unit comprising:
a frame unit forming an interior space therein;
a plurality of side-panels connected to said frame unit, wherein each of said plurality of side-panels extends along a separate vertical plane from the ground when in use, and wherein said plurality of side-panels connected to said frame unit are structured to enclose the cooking unit within the interior space;
a top piece unit connected to a top portion of said frame unit in a covering relation and extending along a plane substantially perpendicular to each of said vertical planes, wherein an opening is formed therein permitting access to the cooking unit.

11. The protective enclosure assembly for a cooking unit of claim 10, wherein said frame unit further comprises a plurality of interconnecting bottom portions, leg portions, and top portions.

12. The protective enclosure assembly for a cooking unit of claim 11, wherein each of said plurality of side-panels are connected to a pair of leg portions of said frame unit in releasably snap-engaging relation.

13. The protective enclosure assembly for a cooking unit of claim 11, wherein said top piece unit further comprises a plurality of top piece-panels.

14. The protective enclosure assembly for a cooking unit of claim 13, wherein each of said plurality of top piece-panels are connected to one of said top portions of said frame unit.

15. The protective enclosure assembly for a cooking unit of claim 10, wherein at least one of said plurality of side-panels comprises at least one vent configured to allow heat to be released from the interior space.
